(19) United States
(12) Patent Application Publication
(10) Pub. No.: US 2016/0254603 A1
(43) Pub. Date: Sep. 1, 2016

(54) ELECTRIC WIRE WITH TERMINAL AND MANUFACTURING METHOD FOR ELECTRIC WIRE WITH TERMINAL

(71) Applicant: YAZAKI CORPORATION, Tokyo (JP)

(72) Inventor: Yutaka TERASAKA, Makinohara-shi (JP)

(73) Assignee: YAZAKI CORPORATION, Tokyo (JP)

(21) Appl. No.: 15/154,080

(22) Filed: May 13, 2016

Related U.S. Application Data
(63) Continuation of application No. PCT/JP2014/080065, filed on Nov. 13, 2014.

(30) Foreign Application Priority Data
Nov. 25, 2013 (JP) 2013-242919

(51) Int. Cl. H01R 4/18; H01R 43/05

(52) U.S. Cl. CPC H01R 4/185; H01R 43/05

(57) ABSTRACT

An insulation sheath is stripped from the tip section of an electric wire, and the tip of the insulation sheath is worked into a conical shape along the entire circumference. During this work, the tip of the insulation sheath is cut such that the conical shape of the tip, where the insulation sheath has been stripped off, is inclined with respect to the axial direction of the insulation sheath. Next, an end part of the conical shape at the tip of the insulation sheath fits inside an insulation barrel. Subsequently, a crimping piece of the insulation barrel is placed between an upper crimping die and a lower crimping die of a terminal crimping machine, and the insulation barrel is crimped by the upper crimping die and the lower crimping die.

### CROSS-REFERENCE TO RELATED APPLICATIONS

This application is a Continuation of PCT Application No. PCT/JP2014/080065, filed on Nov. 13, 2014, and claims the priority of Japanese Patent Application No. 2013-242919, filed on Nov. 25, 2013, the content of both of which is incorporated herein by reference.

### BACKGROUND OF THE INVENTION

1. Technical Field

The present invention relates to an electric wire with a terminal and manufacturing method for an electric wire with a terminal.

2. Background Art

As a conventional electric wire with a terminal and a conventional manufacturing method for an electric wire with a terminal are disclosed in Japanese Patent Application Laid-open No. Hei-11-219735 (hereinafter as “Patent Document 1”). In the Patent Document 1, a tip end of the core wire and a tip end of an insulating sheath are caulkingly crimped by a terminal piece. A pair of projected pieces constituting an insulation barrel are formed while relatively shifted back and forth from each other, and a presser piece is formed in the front end of the forth-side projected piece while being projected forward. The presser piece covers the front side beyond the front rim of the insulating sheath. Consequently, leaping of the front rim of the insulating sheath is prevented.

In the conventional electric wire with a terminal and the conventional manufacturing method for an electric wire with a terminal described above, the status of the insulating sheath covering the electric wire is not viewed by the presser piece. Therefore, it. is necessitated to form an aperture on the terminal piece so as to view the status of the insulating sheath covering the electric wire.

### SUMMARY OF INVENTION

The present invention has been achieved with such points in mind. It therefore is an object of the present invention to provide an electric wire with a terminal and a conventional manufacturing method for an electric wire with a terminal which can facilitate that electric wires are caulkingly crimped by a crimping terminal piece.

To solve the problem and to achieve the object, according to a first aspect of the present invention, there is provided an electric wire with a terminal, includes: an elect wire covered with an insulating sheath, a tip of the insulating sheath being worked tapered as it goes forward along an entire circumference of the insulating sheath; and, a terminal being connected to the electric wire, the terminal having a core wire barrel to crimp a core wire of the electric wire and an insulation barrel to crimp the insulating sheath of the electric wire, the insulation barrel being separated from the core wire barrel, characterized in that an end portion of the worked tapered as it goes forward of the insulating sheath is located so as to be placed inside the insulation barrel; and that the insulating sheath of the electric wire is crimped by the insulation barrel.

An electric wire according to a second aspect of the present invention, in the aspect of the present invention. described above, the tip of the insulating sheath is worked into a conical shape along the entire circumference of the insulating sheath.

An electric wire according to a third aspect of the present invention, in the aspects of the present. invention described above, the tip of the insulating sheath is worked into a stepped shape along the entire circumference of the insulating sheath.

A manufacturing method for an electric wire with a terminal according to a fourth aspect of the present invention, includes the following steps: working a tip of an insulating sheath tapered as it goes forward along an entire circumference of the insulating sheath; setting the electric wire on a terminal in a manner such that at least one portion of the worked tapered as it goes forward of the insulating sheath is located between a core wire barrel and an insulation barrel which are provided on the terminal; and, crimping the electric wire by the terminal.

According to the present invention, a tip of the insulating sheath is worked tapered as it goes forward along an entire circumference of the insulating sheath. According to the simple configuration, it can be avoided that the insulating sheath protrudes form the insulation barrel. Therefore, the simple configuration facilitates that electric wires are caulkingly crimped by a crimping terminal piece, and that the crimping terminal piece can be smoothly inserted in a cavity of a terminal.

### BRIEF DESCRIPTION OF DRAWINGS

FIG. 1A is a plan view showing one embodiment of a crimping structure of an electric wire with a terminal according to the present invention, and FIG. 1B is a side view showing the embodiment.

FIG. 2 shows a configuration of an insulation sheath of a electric wire with a terminal.

FIG. 3 shows a method that an electric wire will be caulkingly crimped by a core wire barrel of a crimping terminal piece.

FIG. 4 shows that an electric wire is caulkingly crimped by a core wire barrel of a crimping terminal piece.

FIG. 5 shows a method that an electric wire will be caulkingly crimped by a insulation barrel of a crimping terminal piece.

FIG. 6 shows that an electric wire is caulkingly crimped by a insulation barrel of a crimping terminal piece.

FIG. 7 shows a status that an electric wire of which of an insulation sheath is not worked into a conical shape is caulkingly crimped by a insulation barrel of a crimping terminal piece.

FIG. 8 shows one improved embodiment of an insulation sheath of an electric wire with a terminal according to the present invention.

### DESCRIPTION OF EMBODIMENTS

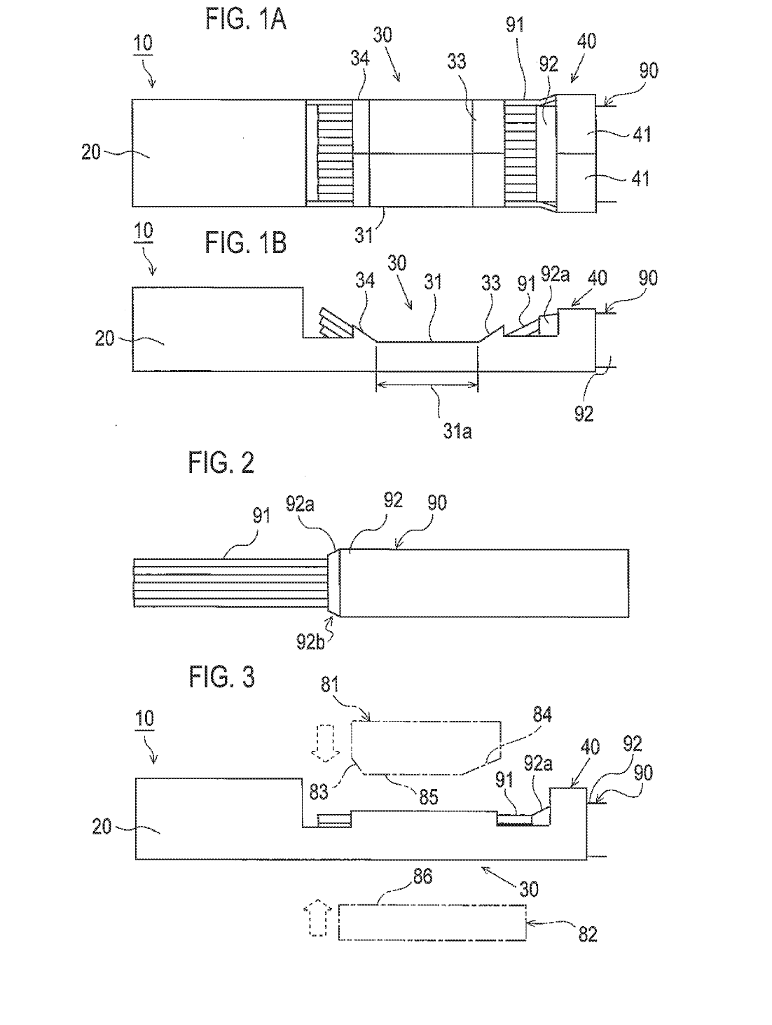

Hereinafter, appropriate embodiments of an electric wire with a terminal and a manufacturing method for an electric wire with a terminal according to the present invention will be explained with reference to the drawings. Here, FIG. 1A is a plan view showing one embodiment of a crimping structure of an electric wire with a terminal according to the present invention, and FIG. 1B is a side view showing the embodiment.

As shown in FIG. 1A and FIG. 1B, a crimping structure of an electric wire with a terminal of the embodiment is configured in an manner that an electric wire 90 is caulkingly crimped by a crimping terminal piece 10.

The crimping terminal piece 10 is made of an electric conductive material by punched out from the plate-shaped electric conductive material and the crimping terminal piece 10 has an electric contact portion 20, a core wire barrel 30 and an insulation barrel (electric wire barrel) 40 which are bent.

The electric contact portion 20 is box-shaped female type and. one end (left end in the figures) in the longitudinal direction of the electric contact portion 20 is opened. The electric contact portion 20 is inserted with another electric contact portion of a male crimping terminal piece.

The insulation barrel 40 is crimped by a terminal crimping machine in a state that the insulation barrel 40 is inserted with an insulating sheath 92 of the electric wire 90, so that the insulating sheath 92 is caulkingly crimped by the insulation barrel 40.

The core wire barrel 30 is formed between the electric contact portion 20 and the insulation barrel 40. The core wire barrel 30 is, in a state that the insulation sheath 92 is stripped from the electric wire 90, and a core wire 91 is disposed, thereby the core wire 91 is crimped with the core wire barrel 30 by a terminal crimping machine.

A middle portion of an upper surface of an crimping piece 31 of the core wire barrel 30 is configured substantially flat, as a completely compressed portion 31a. In the completely compressed portion 31a, the core wire 91 is caulkingly crimped by the crimping piece 31 in completely compressed state. At the both end sides of the completely compressed portion 31a, a rear bell mouth portion 33 and a front bell mouth portion 34 are formed, as remaining portions.

The rear bell mouth portion 33 and a front bell mouth portion 34 are portions which are un-completely crimped by the terminal crimping machine. Consequently, the core wire 91 in the completely compressed portion 31a is un-completely compressed. Therefore, at the rear bell mouth portion 33 and a front bell mouth portion 34, a rear end and a front end of the upper surface of the crimping piece 31 of the core wire barrel 30 are upwardly protruded from the completely compressed portion 31a of the core wire barrel 30. A tip portion of the core wire 91 is upwardly and inclinedly protruded from the front bell mouth portion 34.

A whole of a crimping piece 41 of the insulation barrel 40 is completely crimped by the terminal crimping machine at a whole portion of the crimping piece 41. The insulating sheath 92 together with the core wire 91 is completely compressed by the crimping piece 41. Therefore, in the insulation barrel 40, the insulating sheath 92 crimped by the crimping piece 41 is deformed, and a projected portion of the insulating sheath 92 from the crimping piece 41 is formed as an un-crimped portion. Since the tip of the insulating sheath is worked into a conical shape 92a along the entire circumference of the insulating sheath 92, a length of a projected portion of the insulating sheath 92 is reduced as it goes from a middle portion toward an upper surface end. In other words, an tapered surface is formed on the insulating sheath 92 in a manner such that a diameter of the insulating sheath 92 is reduced as it goes from the tip end of the insulation barrel 40 toward a tip end of the core wire 91 which is removed with the insulating sheath 92.

Hereinafter, a method of forming a crimping structure of the electric wire 90 crimped with the crimping terminal piece 10 will be explained.

When the electric wire 90 is crimped with the crimping terminal piece 10, as shown in FIG. 2, the tip of the insulating sheath 92 of the electric wire 90 is removed thereby exposing the core wire 91, the tip of the insulating sheath 92 is worked into a conical shape along the entire circumference of the insulating sheath 92. During this work, the tip of the insulating sheath 92 is cut such that the conical shape 92a of the tip, where the insulating sheath 92 has been stripped off, is inclined with respect to the axial direction of the insulating sheath 92.

Next, the electric wire 90 is located inside the insulation barrel 40 so as to insert the core wire 91 removed with the insulation sheath 92 of the electric wire 90 into the core wire barrel 30 so that an end portion 92b of the conical shape 92a at the tip of the insulating sheath 92 is located so as to be placed inside the core wire barrel 30.

Subsequently, as shown in FIG. 3, the crimping pie 31 of the core wire barrel 30 is placed between an upper crimping die 81 and a lower crimping die 82 of a terminal crimping machine, the core wire barrel 30 is crimped by the upper crimping die 81 and the lower crimping die 82. The upper crimping die 81 is formed with tapered portions 83 and 84 at a front end and a rear end thereof. On the other hand, the lower crimping die 82 is formed with a crimping surface 86 on the full surface (full flat surface shaped) of the lower crimping die 82.

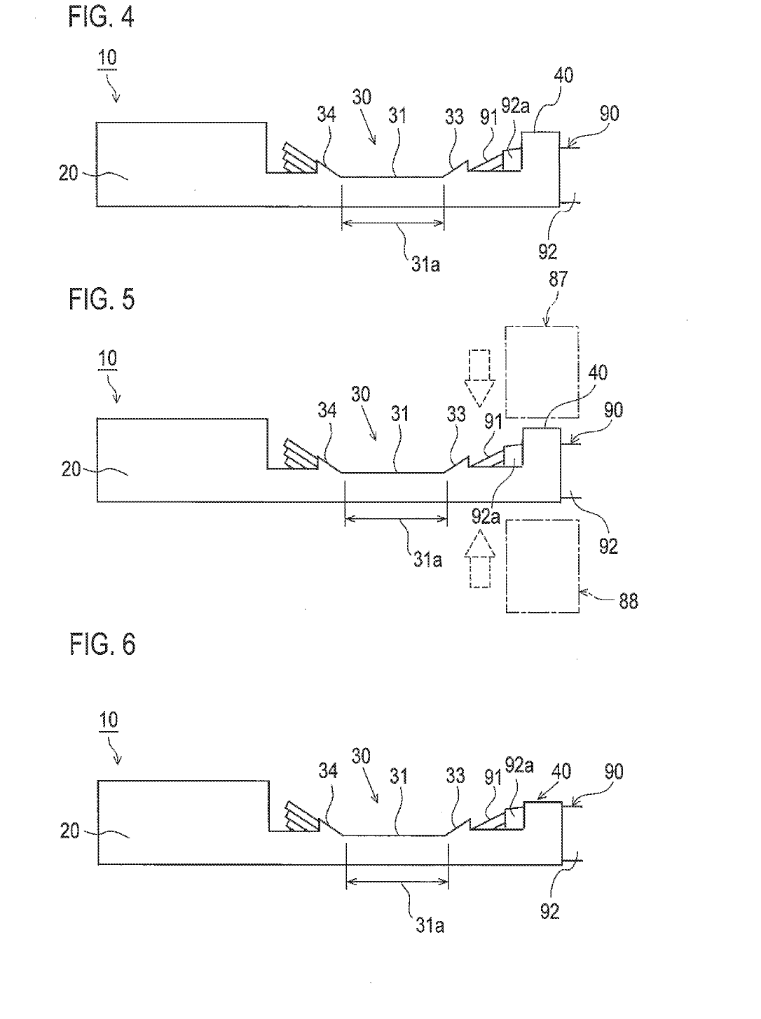

In this connection, after the core wire barrel 30 is crimped by the upper crimping die 81 and the lower crimping die 82, as shown in FIG. 4, the rear bell mouth portion 33 and the front bell mouth portion 34 are formed at the crimping piece 31. In addition, as also shown in FIG. 4, the tip portion of the core wire 91 is upwardly and inclinedly protruded from the front bell mouth portion 34.

Furthermore, as shown in FIG. 5, the crimping piece 41 of the insulation barrel 40 is placed between an upper crimping die 87 and a lower crimping die 88, and the insulation barrel 40 is crimped by the upper crimping die 87 and the lower crimping die 88. After the insulation barrel 40 is crimped by the upper crimping die 87 and the lower crimping die 88, as shown in FIG. 6, the insulating sheath 92 crimped by the crimping piece 41 is deformed, and the projected portion of the insulating sheath 92 from the crimping piece 41 is formed as the un-crimped portion.

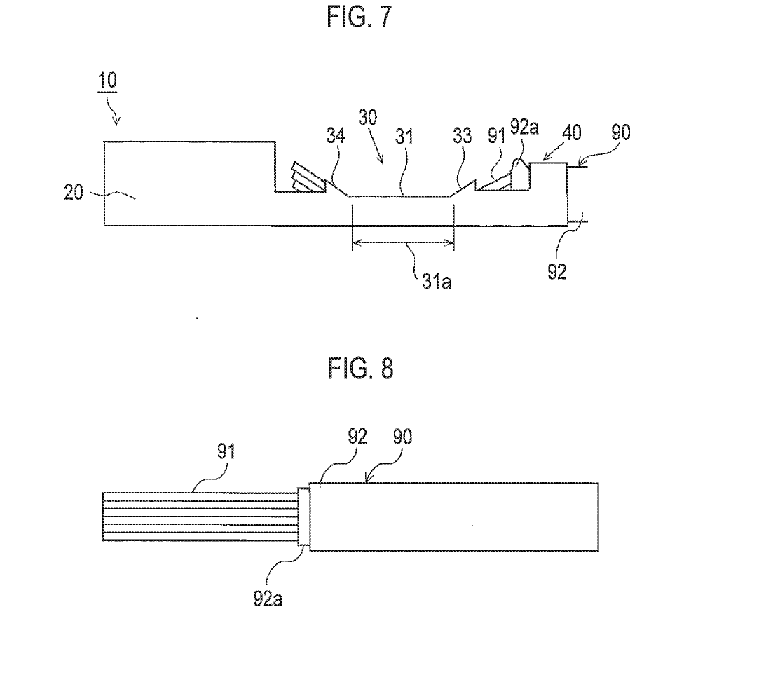

In case, the electric wire 90 where the all tips of the core wire 91 are same lengths (or, the electric wire 90 where the tip of the insulating sheath 92 is not worked into any conical shape) according to the present invention, is crimped with the crimping terminal piece 10, as shown in FIG. 7, a protruded portion of the core wire 91 from the tip end of the bell mouth portion 34 is projected over the height of the bell mouth portion 34.

However, in this embodiment, the tip of the insulating sheath 92 is worked into a conical shape 92a along the entire circumference of the insulating sheath 92. Therefore, even though the electric wire 90 is directed in any angle, the length of the projected portion of the insulating sheath 92 is reduced as it goes from the middle portion toward the upper surface end, as shown in FIG. 6. In other words, the tapered surface is formed on the insulating sheath 92 in a manner such that a diameter of the insulating sheath 92 is reduced as it goes from the tip end of the insulation barrel 40 toward a tip end of the core wire 91 which is removed with the insulating sheath 92.

In this embodiment, since the tip of the insulating sheath 92 of the stripped electric wire 90 is worked into the conical shape along the entire circumference of the insulating sheath 92, even though the electric wire 90 is directed in any angle, the projection of the insulating sheath 92 from the insulation barrel 40 is regulated. Therefore, crimping operation where the electric wire 90 is crimped with the crimping terminal piece 10 can be facilitated. As the results, according to the simple configuration where the tip of the insulating sheath 92 of the stripped electric wire 90 is worked tapered as it goes forward along the entire circumference of the insulating sheath 92, the projection of the insulating sheath 92 from the insulation barrel 40 shown in FIG. 7 is regulated.

In addition, in this embodiment, jamming between the cavity of the terminal and the insulating sheath 92 can be reduced, the crimping terminal piece 10 can be easily inserted inside the cavity of the terminal. Furthermore, most appropriate crimp height is gained.

Here, the embodiment described above, the configuration where the conical shape 92a of the tip of the insulating sheath 92 is inclined with respect to the axial direction of the insulation sheath 92 is explained hereinbefore. However, as long as the tip of the core wire 91 of the stripped electric wire 90 is worked into another conical shape along the entire circumference of the insulating sheath 92, an inclined angle of the conical shape 92a can be varied.

And, in the embodiment described above, the configuration where the electric wire 90 is located so as to be placed inside the insulation barrel 40 so that the end portion 92b of the conical shape 92a of the tip of the insulating sheath 92 is located so as to be placed inside the insulation barrel is explained. However, it is not restricted to this configuration where the electric wire 90 is located so as to be placed inside the insulation barrel 40 so that the end portion 92b of the conical shape 92a of the tip of the core wire 91 is located so as to be placed inside the insulation barrel 40, it can be configured that the end portion 92b of the conical shape 92a of the tip of the core wire 91 is outside the insulation barrel 40

Further, in the embodiment described above, the configuration where the tip of the insulating sheath 92 of the stripped electric wire 90 is worked into the conical shape along the entire circumference of the insulating sheath 92. As long as the tip of the insulating sheath 92 of the stripped, electric wire 90 is worked tapered as it goes forward along the entire circumference of the insulating sheath 92, the configuration can be varied. For example, as shown in FIG. 8, the tip of the insulating sheath 92 of the stripped electric wire 90 is worked into a stepped shape along the entire circumference of the insulating sheath 92.

Depending on the configuration, even though the electric wire 90 is directed in any angle, a length of the projected core wire 91 from the tip of the insulation barrel 40 is reduced as it goes from the middle portion toward the upper surface end. Therefore, even though the electric wire 90 is directed in any angle, as shown in FIG. 7, the projection of the insulating sheath 92 from the insulation barrel 40 can be avoided. Consequently, the crimping operation of the crimping terminal piece 10 to the electric wire 90 is facilitated, and the crimping terminal piece 10 can be easily inserted inside the cavity of the terminal.

The present invention is not limited to the embodiments described above, and the present invention can be variously modified without departing from the scope of the invention.

What is claimed is:

1. An electric wire with a terminal, comprising:
an electric wire covered with an insulating sheath, a tip of the insulating sheath being worked tapered as it goes forward along an entire circumference of the insulating sheath; and
a terminal being connected to the electric wire, the terminal having a core wire barrel to crimp a core wire of the electric wire and an insulation barrel to crimp the insulating sheath of the electric wire, the insulation barrel being separated from the core wire barrel, wherein
an end portion of the worked tapered as it goes forward of the insulating sheath is located so as to be placed inside the insulation barrel; and
the insulating sheath of the electric wire is crimped by the insulation barrel.

2. The electric wire with a terminal according to claim 1, wherein
the tip of the insulating sheath is worked into a conical shape along the entire circumference of the insulating sheath.

3. The electric, wire with a terminal according to claim 1, wherein
the tip of the insulating sheath is worked into a stepped shape along the entire circumference of the insulating sheath.

4. A manufacturing method for an electric wire with a terminal, comprising the steps of:
working a tip of an insulating sheath tapered as it goes forward along an entire circumference of the insulating sheath;
setting the electric wire on a terminal in a manner such that at least one portion of the worked tapered as it goes forward of the insulating sheath is located between a core wire barrel and an insulation barrel which are provided on the terminal; and
crimping the electric wire by the terminal.
